(19) United States
(12) Patent Application Publication
(10) Pub. No.: US 2014/0200930 A1
(43) Pub. Date: Jul. 17, 2014

(54) Methods and Systems for Determining the Importance of Individual Variables in Statistical Models

(71) Applicant: Deloitte Development LLC, Hermitage, TN (US)

(72) Inventors: Frank M. Zizzamia, Collinsville, CT (US); Cheng-Sheng Peter Wu, Arcadia, CA (US); Michael F. Greene, Boston, MA (US); James C. Guszcza, Santa Monica, CA (US); Jun Yan, Avon, CT (US); Jonathan Vanden Bosch, Santa Monica, CT (US); John R. Lucker, Simsbury, CT (US)

(21) Appl. No.: 14/217,231

(22) Filed: Mar. 17, 2014

Related U.S. Application Data
(63) Continuation-in-part of application No. 13/463,492, filed on May 3, 2012.
Application No. 13/463,492 is a continuation of application No. 09/996,065, filed on Nov. 28, 2001, now Pat. No. 8,200,511.
(60) Provisional application No. 61/792,629, filed on Mar. 15, 2013.

(51) Int. Cl. G06Q 40/08

(52) U.S. Cl. CPC G06Q 40/08
USPC 705/4

(57) ABSTRACT

Methods and systems for determining the importance of each of the variables, or combinations of variables, that contribute to the overall score generated by a predictive statistical model are presented. In a specialized case, for each variable in the model, an importance is calculated based on the calculated slope and deviance of the predictive variable. In a more general case, for each variable in the model, an importance is calculated based on setting that variable to have the average value for the data set, and then calculating the change in score. The totality of variables (or combinations thereof) is then ranked by the Δscore, or a magnitude of it, such as |Δscore|.

### CROSS-REFERENCE TO RELATED APPLICATIONS

This is a continuation-in-part of U.S. patent application Ser. No. 13/463,492 titled “Method and System for Determining the Importance of Individual Variables in a Statistical Model” filed on May 3, 2012, which is a continuation of U.S. patent application Ser. No. 09/996,065 of the same title filed on Nov. 28, 2001, now U.S. Pat. No. 8,200,511, which issued on Jun. 12, 2012; this application also claims the benefit of U.S. Provisional Patent Application No. 61/792,629 filed on Mar. 15, 2013. The disclosure of each of the foregoing is hereby incorporated by reference herein in its entirety.

### FIELD OF THE INVENTION

The present invention generally relates to methods and systems for evaluating the results of predictive statistical models, such as, for example, multivariate statistical models, utilizing both linear and non-linear variables, and, more particularly, to determining the contribution of one or more predictive variables, combinations of variables or model terms to scores generated by such models.

### BACKGROUND OF THE INVENTION

One common, exemplary use of multivariate predictive models is in the insurance industry. Insurance companies provide coverage for many different types of exposures. These include several major lines of coverage, e.g., property, general liability, automobile, and workers compensation, which include many more types of sub-coverage. There are also many other types of specialty coverages. Each of these types of coverage must be priced, i.e., a premium selected that accurately reflects the risk associated with issuing the coverage or policy. Ideally, an insurance company would price the coverage based on a policyholder's actual future losses. Since a policyholder's future losses can only be estimated, an element of uncertainty or imprecision is introduced in the pricing of a particular type of coverage such that certain policies are priced correctly, while others are under-priced or over-priced.

In the insurance industry, a common approach to pricing a policy is to develop or create complex scoring models or algorithms that generate a value or score that is indicative of the expected future losses associated with a policy. The predictive scoring models are used to price coverage for a new policyholder or an existing policyholder. As is known, multivariate analysis techniques such as linear regression, non-linear regression, and neural networks are commonly used to model insurance policy profitability. A typical insurance profitability application will contain many predictive variables. A profitability application may be comprised of thirty to sixty different variables contributing to the analysis.

The potential target variables in such models can include frequency (number of claims per premium or exposure), severity (average loss amount per claim), or loss ratio (loss divided by premium). The scoring formula contains a series of parameters that are mathematically combined with the predictive variables for a given policyholder to determine the predicted profitability or final score. Various mathematical functions and operations can be used to produce the final score. For example, linear regression uses addition and subtraction operations, while neural networks involve the use of functions or options that are more complex such as sigmoid or hyperbolic functions and exponential operations.

In creating the predictive model, often the predictive variables that comprise the scoring formula or algorithm are selected from a larger pool of variables for their statistical significance to the likelihood that a particular policyholder will have future losses. Once selected from the larger pool of variables, each of the variables in this subset of variables is assigned a weight in the scoring formula or algorithm based on complex statistical and actuarial transformations. The result is a scoring model that may be used by insurers to determine in a more precise manner the risk associated with a particular policyholder. This risk is represented as a score that is the result of the algorithm or model. Based on this score, an insurer can price the particular coverage or decline coverage, as appropriate.

As noted, the problem of how to adequately price insurance coverage is challenging, often requiring the application of complex and highly technical actuarial transformations. These technical difficulties with pricing coverages are compounded by real world marketplace pressures such as the need to maintain an “ease-of-business-use” process with policyholders and insurers, and the underpricing of coverages by competitors attempting to buy market share. Notwithstanding the recognized value of these pricing models and their simplicity of use, known models provide insurers with little information as to why a particular policyholder received his or her score. Consequently, insurers are unable to advise policyholders with any precision as to the reason a policyholder has been quoted a high premium, a low premium, or why, in some instances, coverage has been denied. This leaves both insurers and policyholders alike with a feeling of frustration and almost helpless reliance on the model that is used to determine pricing.

While predictive scoring models are available in the insurance industry to assist insurers in pricing insurance coverage, there is still a need for a method and system that overcomes the foregoing shortcomings in the prior art. Accordingly, there exists a need for a method and system to interpret the results of any scoring model used in the insurance industry to price coverage. Indeed, the method and system may be used to interpret the results of any complex formula. There is especially a need for a method and system that allow an insurer to determine and rank the contribution of each of the individual predictive variables to the overall score generated by the scoring model. In this manner, insurers and policyholders alike may know with certainty the factors or variables that most influenced the premium paid or price of an insurance policy.

### SUMMARY OF THE INVENTION

Generally speaking, it is an object of the present invention to provide improved methods and systems for determining the importance of each of the variables, or combinations of variables, that contribute to the overall score generated by a predictive statistical model.

In a specialized case, for each variable in the model, an importance may be calculated based on the calculated slope and deviation of the predictive variable. In a more general case, for each variable in the model, an importance may be calculated based on setting that variable to have the average value for the data set, and then calculating the change in score. The totality of variables (or combinations thereof) is then ranked by the Δscore, or an unsigned version of it, such as |Δscore|. Since the score is developed using complex mathematical calculations combining large numbers of parameters with predictive variables, it is often difficult to interpret from the model's scoring formula, for example, why some individuals receive low scores while others receive high scores. A clear understanding of the factors or combinations of factors that drive a score is critical to, for example, identifying potential problems, including remedying the low scoring of otherwise valuable customers.

Additional objects, features and advantages of the invention appear from the following detailed disclosure.

The present invention accordingly comprises the various steps and the relation of one or more of such steps with respect to each of the others, and the product which embodies features of construction, combinations of elements, and arrangement of parts, which are adapted to effect such steps, all as exemplified in the following detailed disclosure, and the scope of the invention will be indicated in the claims.

### BRIEF DESCRIPTION OF THE DRAWINGS

For a fuller understanding of the invention, reference is made to the following description, taken in connection with the accompanying drawings, in which:

FIG. 1 illustrates a system that may be used to interpret and rank the predictive variables according to an exemplary embodiment of the present invention;

FIG. 2 is a flow diagram depicting the steps carried out in interpreting the contribution of each of the predictive external variables in a scoring model according to an exemplary embodiment of the present invention;

FIG. 3 specifies the description of the variables in an example illustrating the application of the method of the present invention to an exemplary scoring formula;

FIG. 4 specifies assumptions made regarding the variables in the exemplary scoring formula;

FIG. 5 specifies the values for the variables used in the exemplary scoring formula, the application of the method of the present invention and the results thereof;

FIG. 6 compares two exemplary approaches for calculating a deviance of a variable in a model;

FIGS. 7-8 illustrate an exemplary multivariate statistical model used to predict workforce attrition, and include various reason codes contributing to an employee's score; and

FIGS. 9-10 illustrate an exemplary multivariate statistical model used to predict default risk of loans to inform collections efforts.

### DETAILED DESCRIPTION OF THE PREFERRED EMBODIMENTS

The invention described and claimed herein creates an explanatory method and system to quantitatively interpret the contribution or significance of any particular variable to a policyholder's profitability score (hereinafter the “Importance”). The inventive methodology takes into account both (a) the overall impact of a variable to the scoring model as well as (b) the particular value of each variable in determining its Importance to the final score.

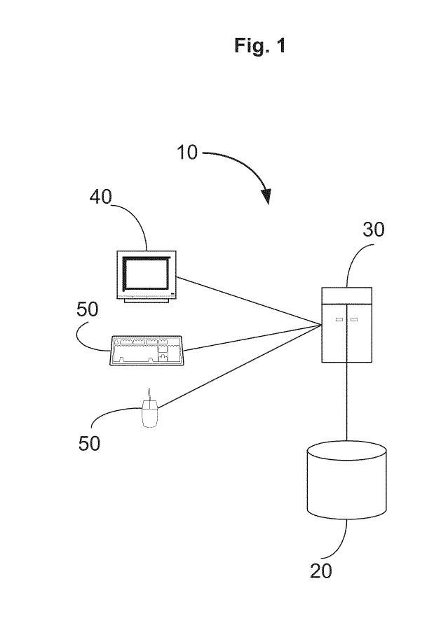

As is known, scoring models are developed and used by the insurance industry (as well as other industries) to set an ideal price for coverage. Many off-the-shelf statistical programs and applications are known to assist developers in creating the scoring models. Once created relatively standard or common computer hardware may be used to store and run the scoring model. FIG. 1 illustrates an exemplary system 10 that may be employed to implement a scoring model and calculate the Importance of individual predictive variables according to an exemplary embodiment of the present invention. Referring to FIG. 1, the system includes a database 20 for storing the values for each of the variables in the scoring formula, a processor 30 for calculating the target variable in the scoring algorithm as well as the values associated with the present invention, monitor 40 and input/output 50 (i.e., keyboard and mouse). Alternatively, the system 10 may be housed on a stand-alone personal computer having a processor, storage, monitor and input/output.

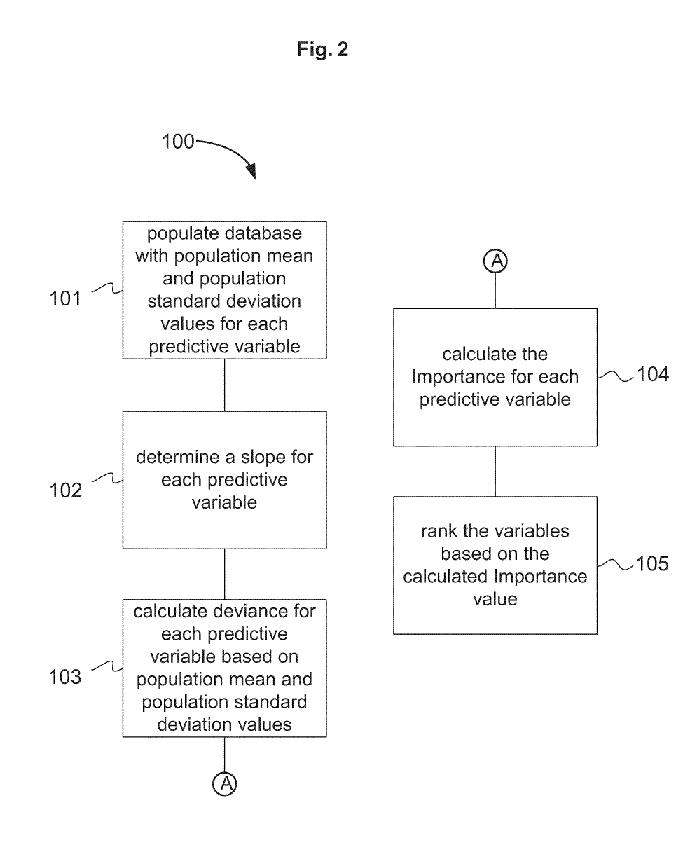

Referring to FIG. 2, the steps of a method according to an exemplary embodiment of the present invention are shown generally as 100. The method assumes a model has been generated utilizing one of many statistical and actuarial techniques briefly discussed herein and known in the art. The model is typically a scoring formula or algorithm comprised of a plurality of weighted variables. The database 20 is populated with values for the variables that define the scoring model. These values in the database are used by the scoring model to generate the profitability score. It should be noted that some of the values might be supplied as a separate input from an external source or database.

Similarly, in step 101, the database 20 or a different database is populated with values for the population mean and standard deviation for each of the predictive variables. These values will be used in calculating the Importance as will be described. Next, in step 102, the slope for each predictive variable in the scoring model is determined. As discussed below, this may be simply done in a scoring mode or require a separate calculation. In step 103, a deviance is calculated. After the deviance is calculated, in step 104, the Importance is calculated for each variable by multiplying the slope by the deviance. The variables are then ranked by Importance in step 105. The higher the value the more important the variable was toward the overall profitability score.

Steps 102 through 104 are now explained in more detail:

### Step 102

The first criterion in determining the most important variables for a particular score is the impact or contribution that each variable contributes to the overall scoring formula. Mathematically, such impact is given by the slope of the scoring function with respect to the variable being analyzed. To calculate the slope, the first derivative of the formula with respect to the variable is generated. For a non-linear profitability formula such as a neural network formula or a non-linear regression formula, the slope may be different from one data point (i.e. policyholder) to the next. Therefore, the average of the slope across all of the data points may be used as the first criterion to measure Importance.

Since the first derivative can be either positive or negative for each data point and since the impact should be treated equally regardless of the sign of the slope, it is necessary to calculate the average of the first derivative and then take the absolute value of the average. In summary, the first criterion in determining the most important variables can be represented as follows:

$$Slope of Predictive Variable {x}_{i} = \vert avg ( \frac{\partial F ( X )}{\partial {x}_{i}} ) \vert$$

(where F(X) is the scoring function which depends on a number N of predictive variables, xi, i=1,2,3 . . . N).

This technique is also directly applicable to the linear regression model results. However, in a linear regression model, the slope of a variable is constant (same sign and same value) across all of the data points and therefore the average is simply equal to the value of the slope at any particular point. Thus, for example, F(X) may be a linear scoring function of the form Y=a0+a1x1+a2x2+ . . . +anxn. Such an exemplary scoring algorithm will, in general, have a partial derivative for each variable, and because the scoring function is linear, the partial derivative of variable xi is just the coefficient ai. This partial derivative is thus the slope of predictive variable xi as shown above. As noted, in such case there is no need to take an average as the slope.

### Step 103

Although the slope impact of a predictive variable as determined in Step 102 is applied to every data point, it is expected that the Importance of any particular variable will be different from one data point to another. Therefore, the overall Importance of a variable should include a measure of its value for each specific policyholder as well as the overall average value determined in Step 102. For example, if the value of a variable deviates “significantly” from the general population mean for a given policyholder, the conclusion might be that the variable played a significant role in determining why that policy received its particular score. On the other hand, if the value of a particular variable for a chosen policy is close to the overall population mean, it should not be judged to have an influential impact on the score, even if the average value of the variable impact (from Step 102) is large, because its value for that policy is similar to the majority of the population.

It is here noted that there are some options in determining which population to use when measuring deviance from a population mean. One may, for example, use the training set population. Or, alternatively, a mean determined from a more recent number of years of data. This may be the implementation data set, or it may be very recent data obtained in the middle of a recalibration period. For example, to create a predictive model, such as a scoring function as described above, a training set is used based on a population database. The scoring function may be a function of a plurality of predictive variables, and as described above, it may be linear or nonlinear in each of those variables. As described below, it may have terms in multiple predictive variables, and one or more of these variables may be taken to a power, or be the argument of some function. Once the scoring function has been created, it may then be applied to a population database, as shown in FIG. 1. This population database may, as shown in FIG. 1, be different than the population database used in creation of the scoring algorithm. For example, in scoring the profitability or riskiness of insurance policies, for example, a training set database based on data collected from the years 2008-2012 may be used to create a scoring algorithm. However, once created, the scoring algorithm will be applied to a different population, such as all proposed insureds from the year 2013, but still use the co-efficients of each term in the algorithm as set at creation. Moreover, in subsequent years the model may be recalibrated to reflect changing trends in applicant data. Assuming that a user of the scoring algorithm recalibrates every two years, the next recalibration date would be in early 2015, and it would recalibrate based on, for example, data from years 2008-2014, or maybe just data from 2013 and 2014. However, in mid 2014 a significant amount of data will already have been collected, and in some exemplary embodiments, where a user of the predictive model or scoring algorithm notes that a definite trend has developed, it may thus be useful to use the data collected from 2013 and thus far into 2014, and create the population mean and population standard deviation values using that data, or even only that data.

Therefore, the second criterion in measuring Importance, Deviance, is a measure of how similar or dissimilar a variable is relative to the population mean, whichever population is decided to be chosen for scoring the population. Deviance may be calculated using the following formula:

$$Deviance of {x}_{i} = \frac{( {x}_{i} - μ )}{{σ}_{i}}$$

where μ is the mean for, and a is the standard deviation for predicitve variable xᵢ. It is understood that the standard deviation is relative to whatever population is chosen, as above.

### Step 104

A final step, 105, defines the Importance of a predictive variable as the product of the slope (Step 1) and the Deviance (Step 2) of the variable, as follows:

Importance=Slope*Deviance

For each policy that is scored, the Importance of each variable may be calculated according to the above methodology. The predictive variables are then sorted for every policy according to their Importance measurement to determine which variables contributed the most to the predicted profitability.

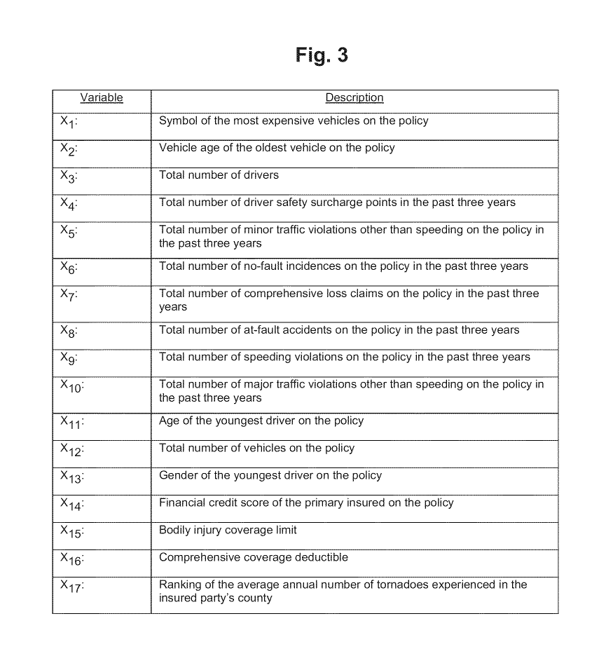

Referring to FIGS. 3 through 5, the Importance calculation is applied to an exemplary situation illustrating the usage of the proposed Importance calculation in a typical multivariate auto insurance scoring formula. In the example, the following should be assumed: (i) a personal automobile book of business is being analyzed, and (ii) the book has a large quantity of data, e.g., 40.000 data points, available for the analysis. In this example, a linear regression formula is used for its simplicity. The formula is a function of 17 variables. X₁ through X₁₇. As described in more detail below, the scoring formula is given as follows:

$$Y = 0.376 + 0.0061 {X}_{1} - 0.0106 {X}_{2} + 0.00593 {X}_{3} - 0.00334 {X}_{4} + 0.011 {X}_{5} + 0.075 {X}_{6} + 0.049 {X}_{7} + 0.027 {X}_{8} + 0.0106 {X}_{9} + 0.061 {X}_{10} - 0.00242 {X}_{11} - 0.062 {X}_{12} + 0.0109 {X}_{13} + 0.000403 {X}_{14} - 0.00194 {X}_{15} - 0.0017 {X}_{16} + 0.000704 {X}_{17}$$

In the above scoring formula, the target variable Y, may be used to predict the loss ratio (loss/premium) for a personal automobile policy. A multivariate technique, which can, for example, be a traditional linear regression or a more advanced non-linear technique such as non-linear regression or neural networks, was used to develop the scoring formula. The formula uses seventeen (17) driver and vehicle characteristics to predict the loss ratio, which are described in FIG. 3.

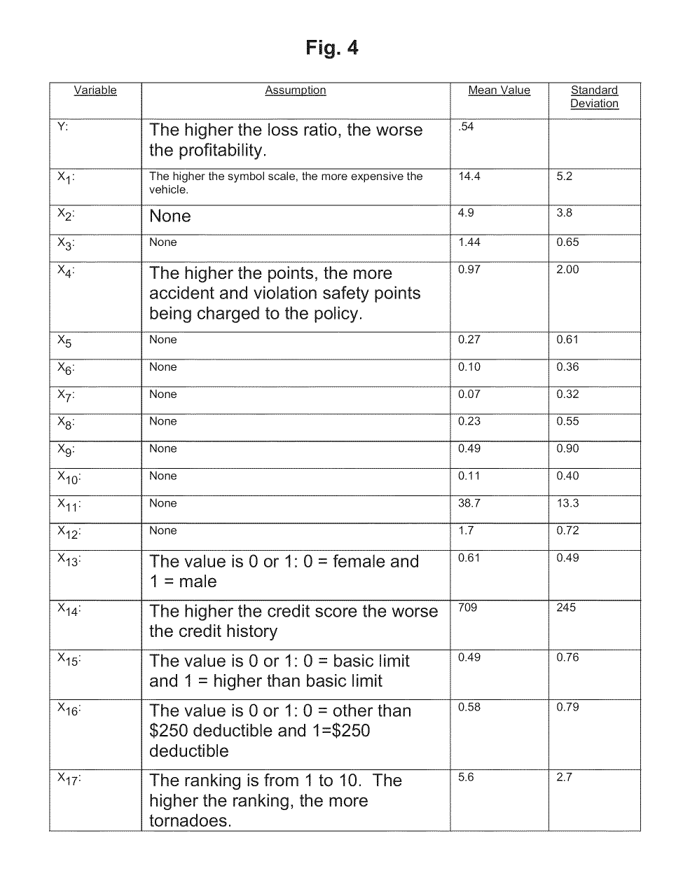

Any assumptions made for the variables are specified in FIG. 4. For each variable, the information gives a further description of the possible values for each variable based on the total population of the data points used in the model development (i.e., the “training set”) and stored in database 20. Additionally, FIG. 4 specifies the Mean of the modeling data population and Standard Deviation for each variable.

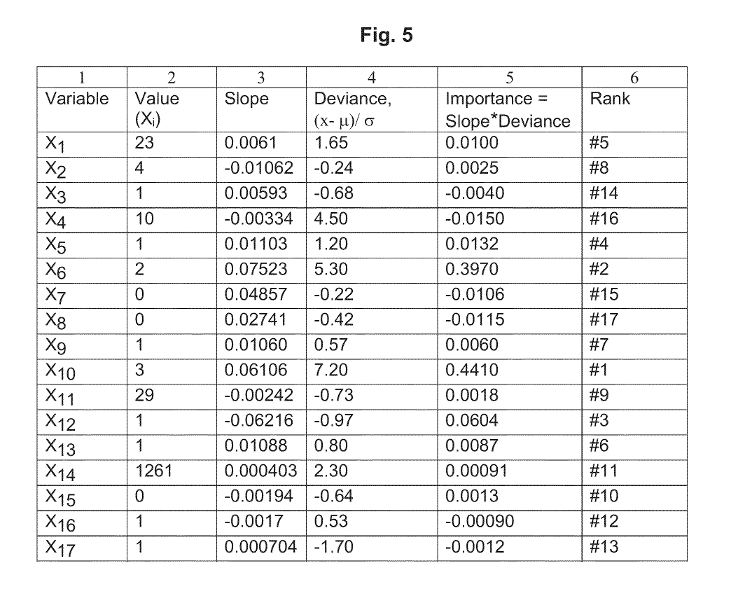

This example illustrates a “bad” (predicted to be unprofitable) policy having the values for the particular variables specified in FIG. 5. The scoring formula contains a constant term, 0.376, and a parameter or co-efficient for each predictive variable. When the parameter is positive, it indicates that the higher the variable, the higher the Y and hence the worse the predicted profitability. When the parameter is negative, it indicates the opposite. For example, the parameter for vehicle age, X2, is −0.0106. This suggests that the older the vehicle, the lower the Y and the better the profitability. It also suggests that as the vehicle age increases by 1 year, the Y will decrease by 0.0106. On the other hand, the parameter for the number of minor traffic violation, X5, is 0.011. This suggests that the more the violations, the higher the Y and the worse the profitability. It also suggests that as the number of the violation increases by one, the Y will increase by 0.011.

Referring to FIG. 5, the solution of the scoring function indicates that the policy under consideration has a predicted loss ratio score of 1.19, which is more than twice the population average of 0.54. A close review of the values of the seventeen (17) predictive variables for this individual (proposed insured) further indicates that there are many bad characteristics. For example, the individual has a number of accidents and violations (X₅, X₆, X₉). He also has a very high number of safety surcharge points (X₄), as well as a bad financial credit score (X₁₄). Also, the vehicle is very expensive (X₁) and the driver is relatively young (X₁₁).

While the policy is obviously a bad policy, the unanswered question is which of the seventeen (17) variables are the key driving factors for the bad score? In other words, if the individual or his insurance broker wishes to understand what are the tipping points that caused the denial of this insurance, what are they? Are the ten (10) driver safety points the number one reason, or the three (3) major violations the number one reason for such a bad score? In addition, if it is clear that it is not any one factor, per se, what are the top 5 most important reasons? In order to address these questions, the Importance of each variable is calculated using the method described above and illustrated in FIG. 2. The first step (102) is to calculate the slope of each predictive variable:

$$Slope of Predictive Variable {x}_{i} = \vert avg ( \frac{\partial F ( X )}{\partial {x}_{i}} ) \vert$$

Since the scoring formula used in the example is a linear formula, the slope is the same as the parameter or coefficient preceding each variable in the scoring formula, as illustrated in column 3 of FIG. 5. The next step (103) is to calculate the Deviance for each predictive variable:

$$Deviance of {x}_{i} = \frac{( {x}_{i} - μ )}{{σ}_{i}}$$

where μ is the mean for xᵢ and σᵢ is the standard deviation for predictive variable xᵢ.

It is noted below that this is but one exemplary method for calculating deviance (“Method 1”), and another possibility is to simply use (xᵢ-μᵢ) without division by σᵢ, (“Method 2”) as described more fully below.

The value (Xᵢ) for each variable of the sample policy is given in the second column, and the population mean and the population standard deviation are given in columns 3 and 4 of FIG. 4. The calculated slope and deviance for each variable are shown in columns 3 and 4, respectively, of FIG. 5. The next step (104) is to calculate the Importance, which is the product of slope and deviance. The calculated importance is given in column 5 of FIG. 5. In a final step (105), from the calculated value of the Importance, the variables can be ranked from highest to lowest value as shown in column 6 of FIG. 5.

The ranking is directly translated into a reasons ranking. From column 6, it can be seen that the most important reason why the sample policy is a “bad” policy is because the policy has three major traffic (X10) violations, compared to the average 0.11 violations for the general population. The second most important reason is that the policy has two no-fault incidences (X6), while the general population on average only has 0.1 violations.

When these two variables are compared to the other fifteen (15) variables, it becomes clear that this policy has values for these two variables that are very different from the general population, as indicated by the high value of deviance. In addition, the parameters (the slopes) for these two variables are also very high, indicating that both variables have a significant impact on the predicted loss ratio and profitability of the policy. In the case of these two variables, the high values of both the slope and the deviance causes these two variables to emerge as the top two most Important factors to explain the bad score for the policy.

It is also noted that the ranking shown in column 6 of FIG. 5, the ranking is by highest contributions to a “bad score.” Thus, any Importance with a negative value is ranked after all the positive Importance values. In other exemplary embodiments, a ranking may be desired only by magnitude of the Importance, and not its sign. Thus a ranking may be by abs {Importance}, or by some other index to the Importance, such as, for example, (Importance)^{N} where N is a power of the importance, which will serve to accentuate the higher contributing factors relative to the lower contributing factors, and can thus create a “natural” spread of Importance values, which sifts out the major contributing variables.

The approach described above to calculate Importance involved calculating RC=β((x−μ)/σ) for each variable in a model and then ranking the variables by their RC values (“RC” stands for “reason code”). RC is determined by the {x}values, which are risk-specific (e.g., different risks will have different credit scores, prior claims, etc.) as well as the (β) values, which pertain to the model, and so apply to all risks in the same way. The {μ,σ} are population estimates of the mean and standard deviation of each of the variables in the model. They are independent of the model but apply equally to all risks.

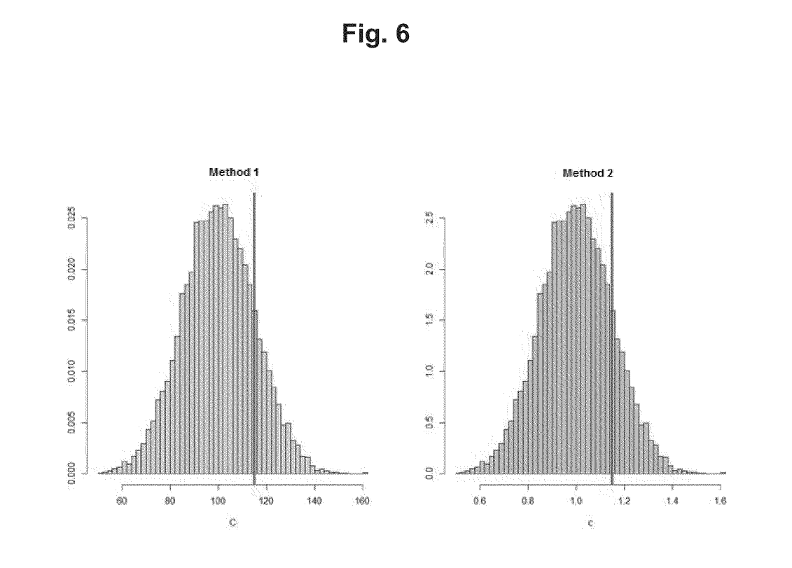

However, it is noted that the above expression of the Deviance may not be sufficiently “scale invariant”. This is illustrated in FIG. 6.

With reference to FIG. 6, suppose that someone using “Method 1”fits a model in which credit takes on values between 50-160, with a mean of 100, and a standard deviation of 15. Suppose further that the resulting model parameter for credit is β_{METHOD1}=−0.002. Now suppose someone else takes this data, divides credit by 100, and refits the model not changing anything else, in what is called “Method 2.” Then, all of the model parameters will be the same except that Method 2's model parameter for credit is β_{METHOD2}=−0.2 (i.e., Method 2's parameter will be 100 times larger than Method 1's).

Now, suppose these two models are each used to score Jim's Coffee Shop workers' compensation risk, for example. The models are algebraically identical, so they will produce the same scores (because the value of credit fed into Method 1's model is 100 times larger than the value of credit fed into Method 2's model). Suppose that in Method 1's data, Jim's credit is 115, and in Method 2's data, Jim's credit is 1.15. Then, in both datasets ((x−μ)/σ)=1. This is because σ is on the same scale as the original x. So σ=15 in Method 1's data and σ=0.15 in Method 2's data. Thus, by the above logic RC_{METHOD1}=β_{METHOD1}((X−μ)/σ)=−0.002 but RC_{METHOD2}=β_{METHOD2}((x−μ)/σ)=−0.2. And, all of the other model variables RC's are the same in both models.

Thus, in some cases, if the β((x−μ)/σ) logic is used to rank variables, one can make credit either the most or the least important variable, based solely on the way one scales credit. But the choice of scale has no effect on the predicted (yhat) model scores. So, this may not be a coherent way to rank-order variables.

Thus, an alternate method is to drop β((x−μ)/σ) and rank the variables using β(x−μ). This is scale invariant. In Method 2's data β is 100 times larger but (x−μ) is 100 times smaller. So, both methods will obtain the same value of β(x−μ).

### Extensions And Advanced Approaches

1. Beyond Linear Models

The Reason Code Algorithm (“RCA”) as presented above is adapted to linear models, such as those of the type Y=a0+a1X1+a2X2+ . . . . +anXn, for example. Given such a model, it is relatively easy to take the partial derivative of Y with respect to each variable x1, x2, . . . xn, and obtain the slope, as defined above. However, to extend the Importance formula provided above, using whichever approach to the Deviance, either normalized or non-normalized, may be computationally much more difficult. Thus, according to exemplary embodiments of the present invention, an alternative formulation of the RCA is provided that generalizes beyond linear models to non-linear and “black box” models, and can be easily implemented in a data processor or computing device.

In exemplary embodiments, as described hereinafter, a linear type Importance includes setting a baseline, and using DELTA=(yhat−mean(yhat))=b1(x1−μ1)+ . . . +bN(xN−μN), and ranking the variables by abs {b(x−μ)}, or some other index or proxy to b(xμmu), such as, for example, [b(x−μ)]². b(x−mu) can be thought of as the variable's “contribution” to DELTA. It is noted that the “b” here is the same as the “β” from the earlier discussion, representing the slope of the scoring algorithm with respect to variable xi.

Alternatively, the functionality of this metric can be generalized, and, thereby, the same contributory effect can be achieved by performing the following steps for each variable in the model:

a. Taking the score yhat for a given risk (or whatever unit of analysis is applicable);

b. Recalculating yhat after replacing x with μx (call this value “yhat_x”);

c. Letting RC_x=yhat−yhat_x; and

d. Ranking the variables by (the absolute value of) RC_x.

It is noted that in the case of a linear model, RC_x equals b(x−μ), precisely as described above. However, this form of the calculation can be used for any model (non-linear and black box).

Machine learning models, or statistical learning modules, are ubiquitous. Many of these models include interaction terms. Interaction terms are those in which two variables are combined in various operations, for example, by multiplying them together. Using the example illustrated in FIGS. 3 and 4, there are 17 variables. It is to be expected that some of the variables could have interaction terms. For example, vehicle age X2, driver age X17 and vehicle status symbol X1, can be combined. With the combination of a young driver, and a new car—that is, a very expensive new car, there is a tendency to be more conscientious about filing a claim even for a small ding or body scratch. Thus, even though, on a linear basis, it may be said that, as the car becomes more expensive you pay more for insurance, however when a car is (i) newer, (ii) expensive, and (iii) driven by a younger driver, use of an interaction term may be very useful, and a very predictive indicator.

Non-linear models are also ubiquitous. Indeed, the best models may have most of their key predictive variables as non-linear, synthetic combinations. Linearity is just a first level approximation.

In a non-linear format, the slope can be very hard to define (in a linear format, the slope is a constant). For the non-linear format, the slope is always changing based on different values; for example, the slope can be a curve.

With reference to the example illustrated in FIGS. 3 and 4, while the age of the youngest driver on an auto insurance policy (variable X11) is linear, the relationship of driver age to insurance risk is U-shaped. That is, while younger is worse (riskier), as the age of the driver increases to a certain point, age again can become a negative factor. This concept can be expressed as a parabolic equation (X² for example). Alternatively, the model (behavior) can be broken into multiple linear or near-linear segments in some complex function

Thus, while the linear Importance, as described above, can be determined by multiplying the slope and the Deviance, in the non-linear world, however, this may be inadequate to define the contribution of a given variable or combination of variables. As noted, for highly complex models, using numerous interaction variables, the slope is not easily obtained. Thus, according to exemplary embodiments of the present invention, contributions are directly calculated—the focus being on how different a variable, or variable combination, is from a baseline value (e.g., average value) for that variable or variable combination. The degree of divergence from the baseline is the contribution.

Thus, according to embodiments of the present invention, for any variable of interest, the contribution may be determined by keeping all other variables unchanged, scoring the model, modifying only the variable of interest to match the baseline value for that data set, scoring the model again, and comparing the scored results. The difference in the final results is the contribution. This can be repeated for any or all predictive variables in the model. The elements of the model can be ranked by this score delta. So, by way of example, in a model having 17 characteristics (variables) the most important and least important of which is not initially known, the characteristic for each variable or combination thereof in the model can be iteratively changed to the average value for that data set, while keeping all 16 other variables unchanged, and the effect on the pre-change score can be calculated.

As referred to above, there is a choice regarding baseline average that may be used in exemplary embodiments. There is one data set, usually the training data set, from which the model was created. This has a certain standard deviation on average. Then, there is a different data set from applied use of the model. This begets a different average. So, which average should be used —the training set that created the scoring algorithm, or the extant average? The contribution for a non-linear model can be determined using either average. In exemplary embodiments, a defined cohort of data for use can be based on time period, region or other desired parameter. Recalibration also is a continuing option.

It is noted that the linear Importance as defined above is a special case of the inventive expansion, and that the inventive expansion works just as well with respect to linear models. Moreover, the inventive expansion works for linear models where, for whatever reason, the partial derivative of an element cannot be calculated with respect to the overall score. Also, the inventive expansion opens up possibilities to rank the contributions of complex moduli used as predictive variables—even where the individual variables are taken to various powers and combined using various operators in such moduli. For example, a given model relating to fluid dynamics may include multiple complex and nonlinear moduli. Calculating the contribution of any one, or all of these to the model's score for a set of fluid dynamic relevant variables is simply impossible.

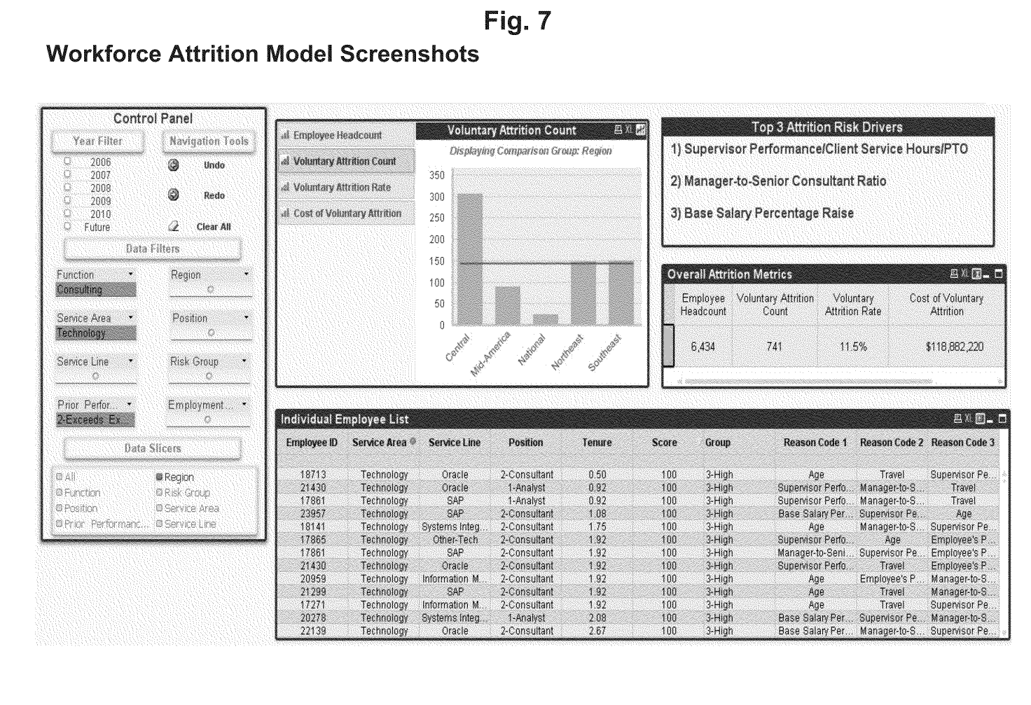

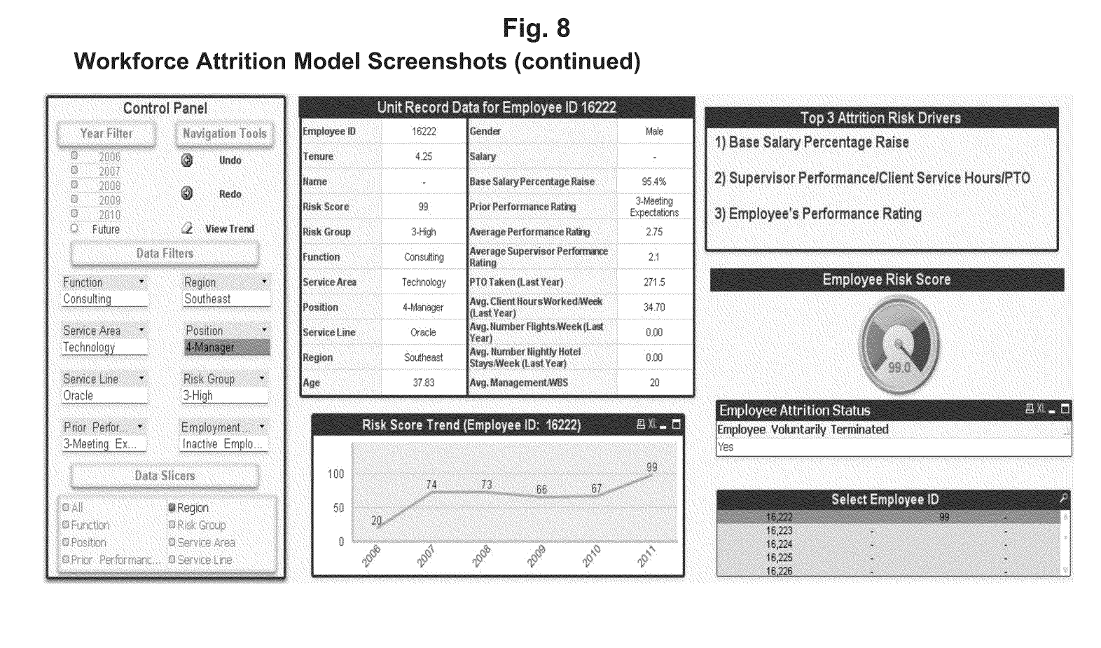

It should be appreciated that application of the present invention is not limited to the insurance industry. The present invention has application with any type of scoring model in any field, both involving human action or human behavior and natural pehnomena. One example is a churn or attrition model, as shown in FIGS. 7-8, which can be used to score or predict the likelihood of employees leaving the employ of a given employer. Scoring attrition allows an employer to identify which of its employees are at risk. As shown in FIG. 7, an attrition model filtered by time period, geographical region, job function, service area, and other factors may yield key drivers of attrition risk, which may include (1) supervisor performance/client service hours/personal time off; (2) manager-to-senior consultant ratio; and (3) base salary percentage raise. Armed with information as to what is driving a scored high risk of attrition, the employer can proactively intervene to keep valued employees (or not).

The present invention also has application in the banking arena, for example. It is known in banking circles that when past due accounts reach 60 days, the probability of default on that account more than triples. So, for example, if a borrower is in the 30-59 day bucket, there might be a 30% chance that the bank will need to take a charge-off compared to a 60% chance if the borrower moves into that 60+ day bucket. Since no bank wants to take a charge-off, action can be taken to try to keep the borrower from getting farther down the delinquency road, and keep good loans on the books. Even if it costs the bank money, it is much preferred to have a performing loan than a charge-off.

Similarly, the present invention has application in the mortgage banking industry for example. If a ranking based on the reason codes is a certain contribution, or a set of contributions, and a mortgagor's data points are being continually monitored, and a change occurs that substantially affects the score, then the mortgagee might want to involve itself further with the mortgagor. Potential actions may be, for example, a loan workout or modification.

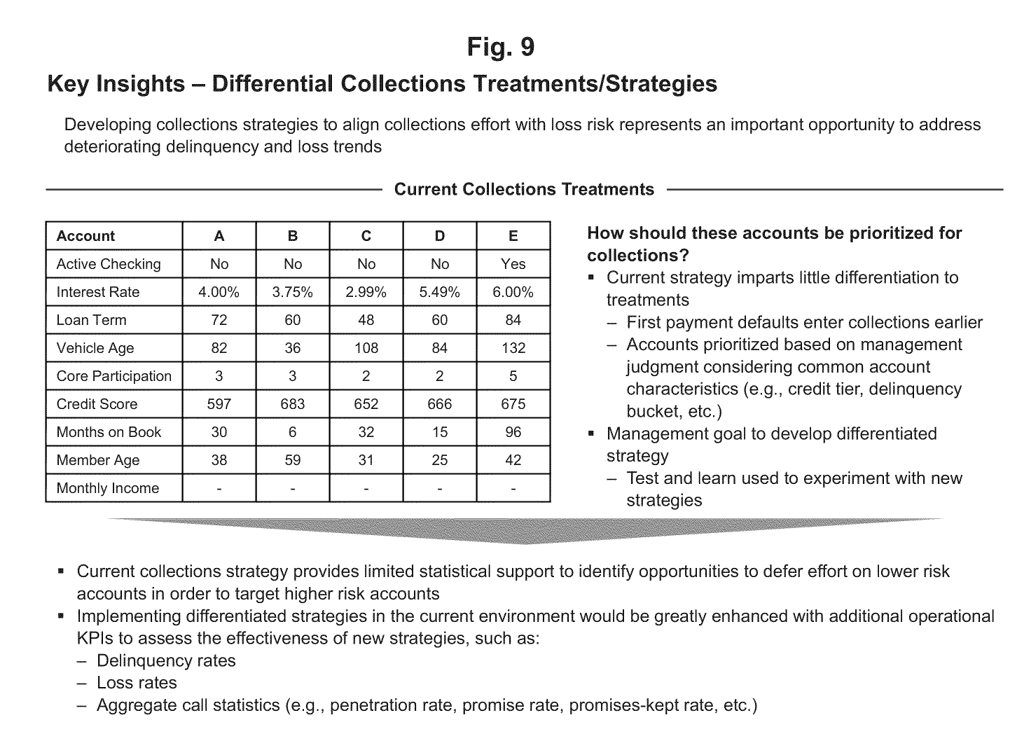

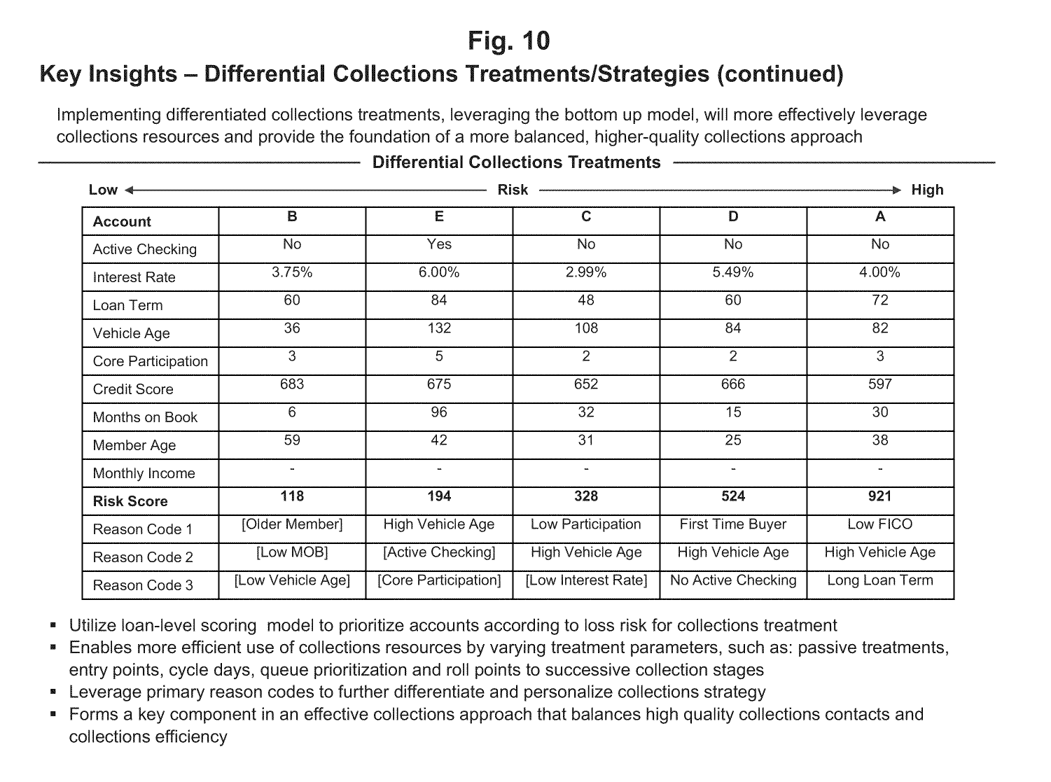

FIGS. 9-10 illustrate yet another exemplary application in the form of a model designed to predict collections risk. As shown in FIG. 10, accounts A through E are rated for collection risk, and each risk score is associated with three Reason Codes that most contribute to or drive it. The present invention can drive efficiencies by allowing the collections department to predict high default risks and to prioritize pre-emptive intervention. Indeed, the present invention may be used to identify factors (including factors that may not be intuitive) that drive default, which can be leveraged to tailor the collections strategy. Depending upon whether the model use dis linear-continuously differentiable or not, one may use the specialized “Importance” described above, or the more generalized “contribution” described in this section. Either will yield the same top X reason codes.

2. Multicollinearity Techniques

a. VARIMAX Rotation

It is not uncommon for predictive models to contain variables that “overlap” with each other to some degree. This is known as “collinearity”. The basic RCA algorithm described above assumes minimal or no collinearity among the predictor variables. In practice, this may not always be the case. In accordance with an embodiment of the present invention, as described in greater detail hereinafter, a method for dealing with potential collinearity can include performing a principal components analysis (“PCA”) on all variables in the model (assume, for example, that there are 30 variables). By performing a VARIMAX rotation, each PC can be given a natural interpretation (e.g., “prior year loss experience”, “3rd prior year loss experience”, “financial stability”, “high-education zip code”, etc.). This yields 30 new variables —each a linear combination of the original 30 variables—that are independent of one another (PC1, PC2, . . . PC30).

A regression model can then be re-run on these 30 new variables:

yhat=d1PC1+d2PC2+ . . . +dNPCN

This resulting new model is algebraically equivalent to the old model. And, the PCs can be ranked by di*(PCi−μPCi). Of course, since μPCi equals zero by construction, this can be equivalently expressed as di*PCi”.

The concept here is that each of the PCs represents a “business dimension”, ranked based on importance per the RCA, with the most important business dimensions being reported as the important factors contributing to the rating.

b. Mutually Exclusive And Completely Exhaustive Variable Clusters

To create another hypothetical example, a model might contain 50 variables, 3 of which are various postal code-level demographic measures; 7 of which are various lifestyle variables, and so on. For example, one variable might be the median age in the postal code (AGE); another variable might be the percentage of people in the postal code who are minors (MINOR), and a third might be the percentage of people in the postal code who are senior citizens (SENIOR). In such situations, when creating reason codes to explain why an individual score is what it is, it would not be conceptually or statistically meaningful to discuss the separate effects of these three variables on the model score. Rather, it would be more meaningful to treat these three variables as three measures of a single overall “model dimension”. This is because the variables move together—they “co-vary”. They convey somewhat redundant information.

Therefore, the set of model variables can be partitioned into a set of mutually exclusive and completely exhaustive (“MECE”) “variable clusters”. In the above example, {AGE, MINOR, SENIOR} may form a single variable cluster. Another cluster might contain 7 variables, and yet another cluster might contain only one variable. The variables within a given cluster will all be related (“correlated” in the statistical vernacular) with each other; but only weakly related (“correlated”) with variables in other clusters. A standard clustering technique, such as, for example, using correlation heatmaps and hierarchical clustering routines, can be used to create the MECE partition of the set of model variables.

Once the variables have been mapped onto to a smaller, MECE, number of clusters, composite indices can be created to mathematically summarize all of the variables within a cluster into a single composite measure. A reliable way to do this is through the use of Principal Components Analysis (“PCA”). In the above example, performing a PCA on (AGE, MINOR, SENIOR) will result in three derived variables, each of which is a linear combination of the three input variables. By construction (owing to the mathematical properties of PCA), each of the three composite measures are mathematically independent (uncorrelated) with one another; and they are ordered in order of diminishing variability. Furthermore, because each PCA is performed on a collection of moderately to highly correlated variables, it is highly likely that only the first PC need be retained, and the others discarded with little effect on any resulting statistical indications.

Supposing then that the 50 original variables are partitioned into 10 clusters, each cluster of variables may then be summarized into a single PC. By the nature of the clustering, these PCs will be only weakly correlated with one another. This is due to the nature of the variable clustering exercise: recall that the variables within a cluster are correlated with each other and weakly correlated with the variables in other clusters. The former fact implies that a single PC can be used to summarize the variables in a particular cluster; the latter fact implies that the resulting PCs will be only weakly correlated with each other.

Thus, having reduced the collection of variables to a smaller number of roughly independent dimensions, it is now possible to naturally decompose a model score into meaningful reason messages. This can be done by performing a regression analysis to approximate the model score as a linear combination of the composite business dimensions (PCs) described above. In the above example, the model score would be approximated as a linear combination of 10 variables, each of which was the first PC of a PCA performed on the variables within a cluster. It is here noted that the relationship will only be approximate because for each variable cluster, all but one of the PCs was discarded. If no PCs were discarded, this regression analysis would result in an algebraically equivalent re-expression of the original model score. However, if the variable partition has been chosen judicially, this approximation will be, in practical terms, close to the original model score.

This modified model can be expressed as follows:

yhat=b1PC1+b2PC2+ . . . +bkPCk

where: yhat denotes the model score: {PC1, . . . PCk} denotes the composite PCs created for each of the k variable clusters (in the above example k=10); and {b1, . . . ,bk} denote the weights determined from this regression analysis.

For the purposes of this example it is assumed that both yhat and the various PCs have been “centered” in such a way that they have a mean value of zero. This is done for ease of exposition, and has no effect on the determination of reason messages. “Centering” simply means that the mean value of a variable has been subtracted from the variable: x_centered=(x−average(x)).

At this point, the task of determining reason messages is straightforward: each principal component (PC) corresponds to a natural language reason message or code. The reason messages can be rank ordered by the absolute value of the corresponding quantities {b1PC1, . . . , b1PCk}. The b parameter is a measure of how important the corresponding dimension (PC) is to the model; on the other hand the value of PC is a measure of how much—or how little—the individual deviates from the population average of this business dimension. Therefore, a large absolute value of biPCi means that business dimension i is a major driver of the overall score (yhat) for a particular individual.

Moreover, suppose that PCi is the composite measure of the “age” dimension measured by the {AGE, MINOR, SENIOR}variables in the above illustration. PCi is therefore a linear combination of these three variables. A very large or small value of this “age” dimension (i.e., PC) would correspond to the individual residing in a particularly “old” or “young” postal code. This could result in “age” being listed as a highly ranked reason message. On the other hand, another individual might reside in a postal code where the “age” PC is 0, corresponding to the population average. For such an individual, “age” would never be a highly ranked reason message. Note also that certain dimensions will appear as reasons more often than others owing to the fact that the corresponding “b” model weight is higher in absolute value than the others. In other words, this dimension is more determinative of the overall model score than others.

c. Subjective Grouping of Variables

As an alternative to the above methods for dealing with multicollinearity, a less formal method is to subjectively group related variables and add up the b(x−μ) for each group. The variable rankings would then be based on these subjective groupings. This method is less mathematically rigorous, but preserves flexibility in making the groupings and also ensures more readily interpretable business dimensions. For business experts who truly have a feel for the industry in which the model is created—often the model creators themselves—this can be a temporary application supplied to agents in the field to easily and quickly evaluate what drives a piece of business having an unacceptable score and taking steps to possibly ameliorate things.

3. Confidence Score/How Many Imputed Variables?

Scored data often contains some proportion of missing values. Missing values are typically handled by assigning (imputing) some value in their place, often the mean of the particular variable in question. Given this context, a method for comparing two observations that the model scores similarly but in actuality have different proportions of imputed missing values can be advantageous. In exemplary embodiments of the present invention, the method may be used to make such a comparison.

Going back to the original model described above, let DEN=SUM(abs(b1*μ1)+abs(b2*μ2)+ . . . +abs(bN*μuN)). Let NUM equal the sum of these terms for which the variable is not missing. If no variables are missing, then NUM/DEN=1. If all of the variables are missing, then NUM/DEN=0. And, in general, NUM/DEN is some number between 0 and 1. b*μ will be higher for an “important” variable than for a “less important” variable. So, NUM/DEN will be lower if an important variable is missing than if a non-important variable is missing. All of these observations motivate interpreting NUM/DEN as a measure of “confidence” in a particular model score, given that the score might have been partially determined by imputed missing values.

4. Additional Features

It should be appreciated that Reason Codes are intended to, inter alia, (a) provide a user interface for the model results, (b) communicate model output to non-technical individuals, and (c) enhance buy-in and compliance for utilizing model results in a business environment. These aims can be supported more fully by a software user interface that reports more than just model scores and reason codes but also enhances or improves the interpretation of models. For example, to increase compliance with model recommendations, an explicit description of incentives can be automatically generated via a follow-up message when a user of the model attempts to override the model recommendations. Behavioral economics concepts can also be leveraged to increase model recommendation compliance.

5. Exemplary Systems

Embodiments of the present invention may be implemented in a computer-readable storage device or non-transitory computer readable medium for use by or in connection with an instruction execution system, apparatus, system, or device. Particular embodiments may be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nano-engineered systems, components and mechanisms. In general, the functions of particular embodiments may be achieved by any suitable means as is known in the art. Distributed, networked systems, components, and/or circuits may be used. Communication, or transfer, of data may be wired, wireless, or by any other suitable means.

In embodiments of the present invention, any suitable programming language may be used to implement functionality—including C. C++, Java, JavaScript, Python, Ruby, CoffeeScript, assembly language, etc. Different programming techniques may be employed such as procedural or object oriented. The routines may execute on a single processing device or multiple processors. Although the steps, operations, or computations may be presented in a specific order, this order may be changed in different particular embodiments. In some embodiments, multiple steps shown as sequential in this specification may be performed at the same time.

Software for calculating linear Importance and non-linear contribution may reside in a module on a PC or data processor, or, for example, there may be an applet that communicates with a system server.

It will thus be seen that the objects set forth above, among those made apparent from the preceding description, are efficiently attained and, since certain changes may be made in carrying out the above method and in the system set forth without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall therebetween.

What is claimed:

1. A method of calculating the contribution of an individual term to a multivariate expression which includes that term, comprising:
obtaining an original result of the multivariate expression;
modifying an individual term of the multivariate expression to an average value for a defined population, and keeping all other terms of the multivariate expression unchanged;
using a data processor, calculating a modified result of the multivariate expression using the modified individual term;
using a data processor, calculating the difference between the original and the modified result, Δresult; and
using a data processor, outputting Δresult to a user as the contribution of the individual term to the result of the multivariate expression.

2. The method of claim 1, further comprising:
repeating the method for at least one additional individual term of the multivariate expression;
ranking the contribution of each of the individual terms by one of: (i) Δresult for each individual term; (ii) the absolute value of Δresult, |Δresult|, for each individual term; (iii) Δresult taken to a power, or (Δresult)ⁿ; and (iv) the absolute value of (Δresult)ⁿ, or |(Δresult)ⁿ|; and
outputting the ranked contributions of the individual term and the additional individual terms to a user, indicating both the contribution, and relative rank, of each individual term.

3. The method of claim 2, wherein the at least one additional term includes all additional terms of the multivariate expression.

4. The method of claim 1, wherein the multivariate expression is nonlinear.

5. The method of claim 1, wherein the multivariate expression includes interaction terms.

6. The method of claim 2, wherein the multivariate expression is nonlinear.

7. The method of claim 2, wherein the multivariate expression includes interaction terms.

8. The method of claim 5, wherein the interaction terms include variables taken to powers, variables as arguments of functions, combinations of multiple variables, or combinations wherein one or more variables are taken to powers or arguments of functions.

9. The method of claim 7, wherein the interaction terms include variables taken to powers, variables as arguments of functions, combinations of multiple variables, or combinations wherein one or more variables are taken to powers or arguments of functions.

10. The method of claim 1, wherein if the value of an individual term, variable or element of the multivariate expression is not available, then the value of the mean for that term, variable or element is interpolated when calculating a result or modified result.

11. The method of claim 10, wherein an index of at least one of (i) how many and (ii) what proportion of terms, variables or elements of the multivariate expression are based on such interpolation is also presented to the user.

12. The method of claim 11, wherein for a multivariate expression:
DEN=SUM(abs(b1*μ1)+abs(b2*μ2)+ . . . +abs(bN*μuN),
Said index is NUM/DEN, where NUM equals the sum of these terms for which the variable is not missing.

13. A system for contribution of an individual term to a multivariate expression which includes that term, comprising:
a database for storing values for various input variables;
a display;
and at least one data processor configured to:
receive a multivariate scoring formula, said scoring formula comprising a sum of a plurality of predictive input variables each having a weighting co-efficient, values for at least some of said variables being stored in the database;
calculate a score using said scoring formula and a set of input variable values;
calculate a partial derivative of the scoring formula with respect to each of the input variables in said set;
calculate a deviance value for each of the input variables in said set, said deviance for a variable xi=(xi−μi), where pi is the mean for predictive input variable xi;
calculate a contribution of one or more of the input variables in said set to the score by multiplying the partial derivative and deviance values for that variable;
create a rank for each of said one or more input variables and display the value of the variable, the score and the rank of the variable to a user.

14. The method of claim 13, further comprising repeating the method for all variables whose values are stored in the database.

15. The method of claim 13, wherein if the value of a variable of the multivariate expression is not available, then the value of the mean for that term is interpolated when calculating a score.

16. The method of claim 15, wherein an index of at least one of (i) how many and (ii) what proportion of terms of the multivariate expression are based on such interpolation is also presented to the user.

17. The method of claim 16, wherein for a multivariate expression:
DEN=SUM(abs(b1*μ1)+abs(b2*μ2)+ . . . +abs(bN*μuN),
said index is NUM/DEN, where NUM equals the sum of these terms for which the variable is not missing.

18. A non-transitory computer readable medium containing instructions that, when executed by at least one processor of a computing device, cause the computing device to:
obtain an original result of the multivariate expression;
modify an individual term of the multivariate expression to an average value for a defined population, and keeping all other terms of the multivariate expression unchanged;
calculate a modified result of the multivariate expression using the modified individual term;
calculate the difference between the original and the modified result, Δresult; and
output Δresult to a user as the contribution of the individual term to the result of the multivariate expression.

19. The non-transitory computer readable medium of claim 18, wherein the instructions, when executed, further cause the computing device to:
repeat the process of claim 18 for at least one additional individual term of the multivariate expression;
rank the contribution of each of the individual terms by one of: (i) Δresult for each individual term; (ii) the absolute value of Δresult, |Δresult|, for each individual term; (iii) Δresult taken to a power, or (Δresult)ⁿ; and (iv) the absolute value of (Δresult)ⁿ, or |(Δresult)ⁿ|; and
output the ranked contributions of the individual term and the additional individual terms to a user, indicating both the contribution, and relative rank, of each individual term.

20. The non-transitory computer readable medium of claim 19, wherein the at least one additional term includes all additional terms of the multivariate expression.

21. The non-transitory computer readable medium of claim 18, wherein the multivariate expression includes interaction terms.

22. A method for dealing with potential collinearity of variables in a multivariate expression of N variables, comprising:
partitioning the set of variables into a set of mutually exclusive and completely exhaustive M variable clusters;
mathematically creating composite indices to summarize all of the variables within a cluster into a single composite measure;
performing a regression analysis to approximate an output of the multivariate expression as a combination of the composite indices;
rank ordering by absolute value of the composite indices and their co-efficients; and
outputting the combination of composite indices and the ranked order to a user.

23. The method of claim 23, wherein the composite indices are substantially independent.

24. The method of claim 23, wherein the regression analysis is a principal components analysis.

25. The method of claim 24, wherein the output of the multivariate expression is approximated as a linear combination of M variables, each of which is the first PC of a PCA performed on the variables within a cluster.

26. The method of claim 25, where the modified multivariate expression is expressed as:
yhat=b1PC1+b2PC2+ . . . +bkPCk
where: yhat denotes the output of the modified multivariate expression, {PC1, . . . PCk} denote the composite PCs created for each of the M variable clusters, and {b1, . . . ,bk} denote the weights determined from the regression analysis.

27. The method of claim 26, wherein a rank ordering by the absolute value of the corresponding quantities {b1PC1, . . . , b1PCk} is performed and output to the user.
